(19) United States
(12) Patent Application Publication
(10) Pub. No.: US 2005/0230272 A1
(43) Pub. Date: Oct. 20, 2005

(54) Porous biosensing device

(76) Inventors: Gil U. Lee, West Lafayette, IN (US); Jin-Won Park, West Lafayette, IN (US); Zhigang Wang, Aurora, CO (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 11/035,431

(22) Filed: Jan. 14, 2005

Related U.S. Application Data
(63) Continuation-in-part of application No. 10/491,686, filed on Jul. 23, 2004.
(60) Provisional application No. 60/326,862, filed on Oct. 3, 2001.

(51) Int. Cl. G01N 27/26

(52) U.S. Cl. 205/792; 204/403.01; 427/2.11

(57) ABSTRACT

This invention relates to the biosensor devices, their fabrication and use. The biosensor devices comprise a substrate supporting an array of microwells where each microwell can contain a biocompatible fluid and a membrane having a membrane protein of interest. In use the microwells can be addressable to detect and analyze a variety of analytes.

### CROSS-REFERENCE TO RELATED APPLICATION

The present application claims priority to and is a continuation-in-part of U.S. patent application Ser. No. 10/491,686 filed on Apr. 2, 2004, which is a national stage filing of WO 03/052420 (PCT/US02/31772) filed on Oct. 3, 2002, which in turn claims priority to U.S. Provisional Patent Application Ser. No. 60/326,862 filed on Oct. 3, 2001, each of which is incorporated by reference in its entirety.

### BACKGROUND OF THE INVENTION

Biosensors are employed in a large and rapidly increasing number of important medical and environmental applications. Mechanistically, biosensors can be classified as having affinity, catalytic, membrane protein, and cell-based molecular receptors. The affinity and catalytic sensors are readily, commercially available, while membrane protein and cell-based sensors are an emerging technology. An important technical advantage of the affinity and catalytic sensors is that they can be preformed on glass, polymer, and cellulose surfaces (or substrate) that allow for the rapid solid phase extraction of the analyte from the sample. For example, the enhanced sensitivity and speed of affinity sensing executed on nitrocellulose-based substrates, often referred to as dot-blot or dipstick assays, are thought to be due to the enhanced surface area and wicking properties of the substrate, which, in turn, drive mass transport and the reaction kinetics of the molecular recognition reaction.

Recent advances in the microfabrication of biosensors are enabling new modes of biosensing applicable to membrane protein and cell-based molecular receptors. Some of the advances afford more precise control over fluid handling and stable temperature maintenance. Consequently, these new lab-on-a-chip (LOC) technologies are rapidly being developed now that standard fluidic components have been developed and plastic micromachining techniques have been implemented to reduce costs. Still, sampling and analysis of analytes in complex biological environments remains a major challenge for LOC devices.

There is a continuing need for advancements in the relevant field, including improved biosensor devices and methods for analysis of biological processes. The present invention is addressed to these needs.

### SUMMARY OF THE INVENTION

The present invention relates to biosensor devices, the manufacture, and use thereof. Various aspects of the invention are novel, nonobvious, and provide various advantages. While the actual nature of the invention covered herein can only be determined with reference to the claims appended hereto, certain forms and features, which are characteristic of the preferred embodiments disclosed herein, are described briefly as follows.

In one form, the present invention is directed to analysis of biochemical reactions that can be executed on biosensors having a foundation of a nanoporous substrate that have been integrated into a polymer LOC device. The LOC device can include an array of microwells supported on the substrate, each microwell having a membrane, typically overlaying a fluid cassette or chamber. Controlled delivery of specific reagents can be achieved to either or both the front and back of the substrate and/or membrane. In selected embodiments, precise control of the chemical environment on the two sides of an interface at which a reaction is taking place provides new modes of sensing that can improve one or more of the sensitivity, response time, and stability of the sensors. For example, the sensitivity and response time of the sensors can be enhanced by active control of the concentration of the analytes and reagents at the membrane surface and/or in the fluid chamber underlying the membrane. The stability of molecular receptors, catalysts, and cells can be enhanced by delivering specific reagents or nutrients to the membrane surface.

In another form, the present invention provides a biosensing device that comprises: a nanoporous substrate having first surface and an opposite second surface; a film overlying the first surface, where the film defines a plurality of reaction wells each well having a volume of less than about 10 nL and extending into the film to expose a portion of the first surface; a biocompatible medium disposed in each of said reaction wells; and a membrane disposed on top of the biocompatible medium.

In another form, the present invention provides a biosensor device. The biosensor device comprises: a membrane having an outer surface and an inner surface; a protein transducer directionally oriented with the membrane film; and a nanoporous substrate in fluid communication with the inner surface of the membrane film. The substrate has a plurality of reaction wells, where each well has a volume of less than about 10 nL. The reaction wells provide a chamber or cassette between the membrane film and the support substrate.

In yet another form, the present invention provides a method for fabricating a biosensor device. The method includes overlaying a first surface of a nanoporous substrate with a polymeric layer; defining a set of reaction wells extending through the polymeric material to expose a portion of the first surface of the nanoporous substrate, where each of the reaction wells has a volume of less than about 10 nL; and depositing a membrane in the reaction wells.

In still yet another form, the present invention provides a method of bioanalysis. The method comprising: depositing a compound or biologic of interest onto a selected, addressable reaction well in an array of wells. The wells are defined on a substrate, where each well is configured to have a volume of less than about 10 nL, includes a fluid medium overlaid by a membrane and a membrane protein. The presence or activity of the compound or biologic of interest in the fluid medium is then detected using a detectable species or an indicator moiety.

Further objects, features, aspects, forms, advantages and benefits shall become apparent from the description and drawings contained herein.

### BRIEF DESCRIPTION OF THE DRAWINGS

FIGS. 1A and 1B are perspective views of one embodiment of a biosensing device in accordance with the present invention.

FIG. 2 is a cross-sectional view of one embodiment of a biosensor including two membrane layers placed back-to-back.

FIG. 3 is a schematic representation of different, supported membrane configurations: (a) polymeric chains attached to both the support and the membrane; (b) polymeric chains attached only to the solid support; and (c) polymeric chains grafted to one material, either the support or the membrane.

FIG. 4 is a schematic illustration of structures of naturally occurring bolalipids isolated from the thermophilic archaebacteria.

FIG. 5 is an illustration of representative examples of synthetic bolalipids that form stabilized, supported membranes.

FIG. 6 is an exploded view of an alternative embodiment of a biosensing device in accordance with the present invention.

FIG. 7 is an exploded, cross-sectional view of the biosensing device of FIG. 6.

FIG. 8 is an exploded, cross-sectional view of another embodiment of a biosensing device in accordance with the present invention.

FIG. 9 is an exploded cross-sectional view of a biosensing device enclosed within filtering membranes in accordance with the present invention.

FIG. 10 is a scanned image of an optical micrograph of an aluminum substrate with three arrays of reaction wells, 200, 300, and 400μ in diameter, prepared in accordance with the present invention.

FIG. 11 is a scanned image of HRP catalyzed colorimetric reaction in a non-porous biosensor device in accordance with the present invention.

FIG. 12 is a scanned image of an optical micrograph of a microreactor array with reactors 400, 500, and 600μ in diameter.

FIG. 13 is a schematic of an inkjet arrayer and inverted optical microscope assembly for use in accordance with the present invention.

FIGS. 14 and 15 are scanned images of a printing head approaching the micropattern on a glass substrate for use in accordance with the present invention.

FIG. 16 is a scanned micrograph of a microfabricated reactor array each with a fluid medium and maintained at less than 95 to 100% relative humidity.

FIG. 17 is a scanned image of an optical micrograph of a microfabricated reaction array each with a fluid medium and maintained at about 100% relative humidity for more than two hours.

FIG. 18 is a schematic illustration of a microreactor well with a membrane formed of a plurality of lipid vesicles in accordance with the present invention.

FIG. 19 is a scanned micrograph of a fluorescence image of a microfabricated reactor array with lipid vesicles having gramicidin molecules embedded within the lipid membrane.

FIG. 20 is a scanned fluorescence image of a microfabricated reactor array with lipid vesicles sans gramicidin molecules.

FIG. 21 is a plot illustrating the relative fluorescence intensity relative to pH and the number of acid drops added to each reaction well of the reactor of FIG. 19.

### DETAILED DESCRIPTION OF THE INVENTION

For the purposes of promoting an understanding of the invention, certain biosensor devices, their preparation, and use are discussed. It will nevertheless be understood that no limitation of the scope of the invention is thereby intended. Any alterations and further modifications in the devices, their fabrication, and application as described herein are contemplated as would normally occur to one skilled in the art to which the invention relates.

The present invention provides a biosensing device that includes a substrate supporting a plurality of reaction wells. The substrate can be composed of a variety of materials. In one embodiment, the substrate is composed of a nanoporous material. The reaction wells are individually addressable, capable of being individually dosed, and sized as desired. A membrane can be contained within the reaction well to allow for the investigation of biochemical signaling, membrane transport mechanisms, the analysis/identification of specific components capable of being transported across a lipid membrane, membrane receptors, and/or proteins or other membrane species that can facilitate transport across the lipid membrane. An indicator moiety in a fluid media can also be contained in the individual reaction wells. The indicator moiety can indicate when transport across the lipid membrane occurs, by being detectable either optically, chemically, electrochemically, or by other types of detectable signals.

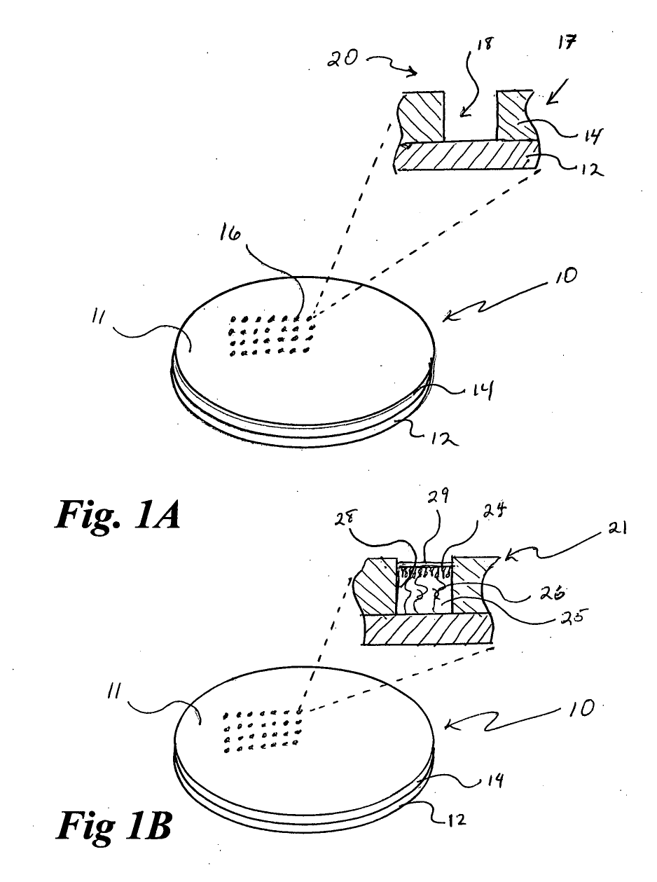

FIG. 1A is a schematic illustration of one embodiment of a biosensor device 10 for use in the present invention. Biosensor device 10 includes a chip or wafer 11 comprising a substrate material 12 on which is formed or laminated a polymeric layer 14 having a plurality of microreactors 16 formed therein. A magnified view of one microreactor 17 is further illustrated in the enlarged inset represented by reference number 20. Referring specifically to the enlarged inset 20, microreactor 17 includes a small well 18 that can serve as a container or cassette in which a variety of different reactions and/or analysis can be performed. By why of examples, well 17 can contain select reagents to perform either a specific analysis of various antibodies, enzyme and membrane proteins, as well as various environmental analytes of interest.

FIG. 1B illustrates biosensor 10 in which the microreactor 21 includes a lipid layer 24 which is constrained within the microreactor by a bivalent tether group 26. Referring specifically to the enlarged inset of a single microreactor 21, it can be seen that in the illustrated embodiment, the lipid membrane 24 is tethered to the surface of substrate material 12. It will be understood that in other embodiments lipid membrane 24 can be secured to or tethered to the side wall(s) 28 of the microreactor 21 or contained within the microreactor by other means such as a hydrophobic interaction. While lipid layer 24 is constrained within microreactor 21, the lipid layer nonetheless retains a degree of mobility or fluidity.

A fluid medium 25 can be deposited in the well of the microreactor. Additionally, a liquid covering 29 can overlay at least a portion of lipid layer 24. The liquid covering 29 can be applied during fabrication of the biosensor 10. Alternatively, liquid covering 29 can be deposited after fabrication of biosensor 10. In certain embodiments, the liquid covering 29 is deposited during use of biosensor 10 and contains one or more analytes or other bioactive agents useful for analysis. Liquid covering 29 can be deposited as more fully described below in a reliable, controlled volume in a specifically addressable set of microreactors.

The substrate material 12 can provide mechanical support for the reaction wells. The support is not limited by any type of material used for fabrication. The substrate material can be a meso- or nanoporous material; a solid material, or an imperforate material. Suitable materials for use in fabricating the support substrate include, without limitation, anionic γ-alumina, nanoporous silicon structures, glass, gold (Au), electrodes, and indium tin oxide (ITO) materials. Additionally, second generation materials, such as nanoporous structures (e.g., SBA-15 and γ-alumina), can be used.

In certain embodiments, other mirco-, meso- or nanoporous aluminum materials are used to support the reaction wells and membranes. Preferred nanoporous support materials are suited for incorporation into the present invention because they can be formed to have highly uniform pores of sizes ranging in diameter from 1 to 500 nm. Selected substrates can exhibit high elastic modulus and can withstand particularly high temperatures.

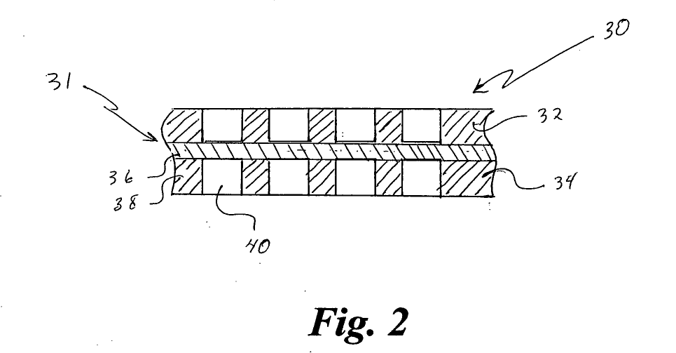

Support material 12 can be formed of a single layer or alternatively of two or more layers of material or membranes as illustrated in FIG. 2. Biosensor 30 includes a wafer 31 comprising a first substrate layer 36 overlaid with a first membrane 32 and an opposite second membrane 34. Each membrane 32 and 34 can define a plurality of microreactors 40.

In certain embodiments, the reaction wells are formed in or extend through a polymeric coating, which has been deposited on the substrate material. For example, the reaction wells can extend through the deposited polymeric coating to expose a portion of the underlying substrate. In preferred embodiments, the biosensor device can have a reaction well density of between 1 and 1000 wells/mm, more preferably between 10 and 100 wells/mm. In one embodiment, the reaction wells are formed by overlaying a polymeric material directly over the nanoporous substrate without any intervening bonding layer or coating.

The polymeric material overlaying the substrate can be composed of a variety of materials. Examples of material for use in the present invention include commonly known photoresist materials (either positive or negative photoresist materials).

The reactions wells on the nanoporous substrate can be formed using a variety of known techniques. In certain embodiments, an array the reaction wells can be formed using photolithographic techniques. In other embodiments, laser etching of an overlying polymeric or ceramic material can be accomplished to provide the array of reaction wells.

Still other techniques include contact printing with pen tools. This is a relatively inexpensive method and typically may not be able to achieve spot sizes smaller than about 100μ². Still other techniques use soft lithography as described in Younan Xia, and George M. Whitesides, “Soft Lithography” Angewandte Chemie International Edition, 1998, 37, 550-575. This process includes using a master stamp prepared using conventional lithographic techniques and then using the stamps to imprint the features onto polymeric substrates. Features as small as 30 nm can be formed using this technique.

One primary advantage of using photolithographic techniques over other techniques is, for example, photolithographic techniques can be exploited to achieve extremely high-density arrays. This technique is easily capable of creating reaction well sizes of 10μ by 10μ or smaller.

Once the microwells have been defined into the wafer, inkjet technology can be used to deposit the fluid medium, the lipid membrane, and/or the analyte for analysis. These three components, as well as others if desired, can be injected into the reaction wells in a single step or through a series of deposition steps. Additionally, the inkjet can deliver a fluid medium in varying quantities. In one form of analysis, a typical four nozzle inkjet head can be used. Three of the inkjet nozzles can be assigned to deliver three different reagents, analytes, or indicator moieties as desired. The fourth inkjet nozzle can be used to deliver a fluid medium such as a buffer solution. This fourth nozzle can also be used to vary the amount of fluid either by varying the drop size of the number of drops delivered to specific reaction wells.

When desired, the reaction wells formed in the biosensing device can include a biomimetic membrane. The membrane can be a monolayer or a bilayer and can further include various components such as transmembrane proteins, protein transducers, and receptors. The additional components can be introduced into the reaction wells simultaneously with the membrane, prior to, or subsequent to the addition of the membrane. The membrane structure can be covalently tethered to either the sides or the bottom of the reaction well. Alternatively, the membrane can be constrained via hydrophobic interactions between linking groups, discussed more fully below.

The membrane can be formed from one or more natural or synthetic materials, such as lipids, monolipids, bilipids, a bolaamphiphile, a triblock copolymer, a hydrogel, or other hydrophobic materials. Examples of lipids include archaebacterial lipids from halophilic bacteria and Methanogen (i.e., any of the various archaebacteria (see Archaea) that produce methane; they include such genera as Methanobacillus and Methanothrix), and bacterial bolalipids from thermophilic bacteria are particularly useful. Other materials that can be used for the biomembrane film include, for example, non-fouling template-polymerized bilayers, bolaamphiphiles, triblock copolymers (such as PEG-PiB-PEG and PEO-PPO-PEO), and hydrogels. The membrane film is preferably planar. See, e.g., Salafsky et al., Biochemistry, 1996, 35, 14773-14781; Raguse et al., Langmuir, 1998, 14, 648-659; Groves et al., Langmuir, 2001, 17, 5129-5133; and Groves et al., Biophys. J., 1996, 71, 2716-2723; and U.S. Pat. No. 6,228,326, Boxer et al. for examples of supported membrane films. The use of synthetic lipids or lipid-like molecules allows the incorporation of structural modifications that can increase the stability of the supported membrane.

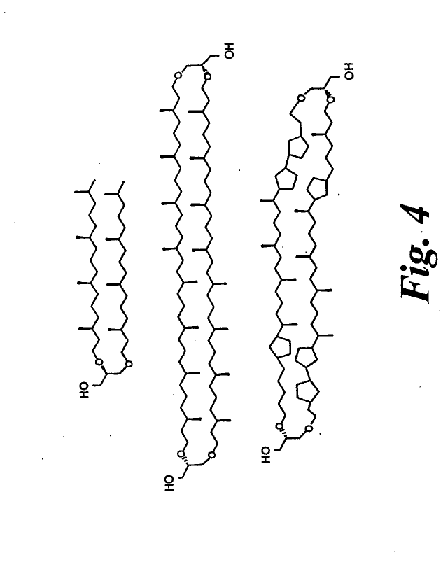

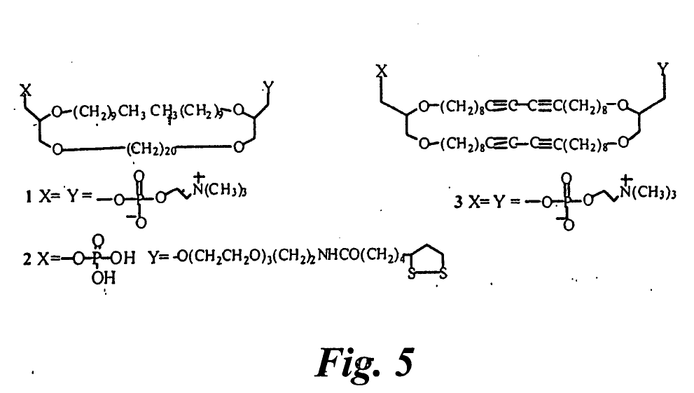

The membrane film can take the form of a bilayer, such as a lipid bilayer, or it can take the form of a monolayer structure. Naturally occurring lipids, with polar head groups and hydrophobic tails, typically form a bilayer. It has been shown that supported membrane film arrays can be formed by liposome fusion with microcontact printed surfaces. Analysis of these films has revealed that the membrane bilayers retain their fluidity via entrapment of a nanometer-sized aqueous phase in a chamber or cassette between the membrane coating and solid support. Proteoliposome fusion with solid supports has further shown that proteoliposome can fuse with acid-treated glass surfaces to give supported membranes with the membrane proteins oriented in a vectorial fashion. However, supported bilayer membranes tend to delaminate from the solid support within 24 hours. Accordingly, in certain embodiments, a monolayer membrane is preferred for the membrane film of the biofunctional component of the device. A monolayer structure can be formed from, for example, bolalipids, bolaamphiphiles, or amphiphilic tri-block copolymers. Representative examples of naturally occurring bolalipids are illustrated in FIG. 4. FIG. 5 illustrates representative examples of synthetic bolalipids. Supported bolalipid membranes are especially preferred. Additionally, or in the alternative, lipid components of the membrane can be tethered to the support substrate as discussed in Cornell et al., Nature, 1997, 387:580-583.

The membrane can be constrained to the inside of the reaction well. As discussed below, in one embodiment the lipid membrane is covalently tethered to either the side walls of the reaction well, the end or base of the reaction well, and/or to the exposed nanoporous substrate. One method of tethering the lipid membrane is to embed a tethered protein transducer or a membrane protein into the membrane. For certain applications, the lipid bilayer is tethered yet still allows membrane fluidity to mimic or model naturally occurring membranes, for example, extracellular membranes. Fluidity is also important to ensure that the embedded proteins can move within the membrane. Membrane fluidity can be achieved in a number of different ways. In one embodiment, the tethering or bivalent linking group can be tethered to a protein transducer, an embedded protein, or to the polar head of the membrane component (e.g., the acetylcholine portion of the phospholipid component).

The bivalent linking group can be selected from a variety of components. In one example, the bivalent linking group is a PEG moiety or a poly(ethyleneimine) moiety (PEI). In preferred embodiments, the nanoporous substrate exposed at the bottom of the reaction well is saturated with a plurality of PEG linking groups to provide a “PEG layer”. The PEG molecules or moieties can be chemically bound to either or both the underlying substrate and/or the walls of the microreactor. As noted above, the other end of the PEG molecule can be bound directly or indirectly either to a protein embedded within the membrane or to the membrane itself, e.g., an amphiphilic unit.

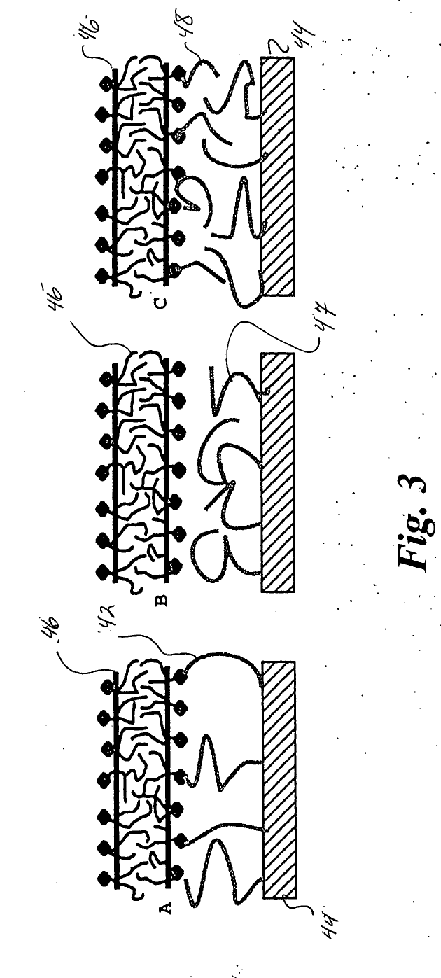

Referring now to FIG. 3A which is a partial cross-section of a microreactor illustrating PEG molecules 42 that are chemically bound to both the support 44 and the lipid membrane 46. FIG. 3B illustrates an embodiment in which the PEG molecule 47 is chemically bound to the support but not directly to the lipid membrane 46. The polymer layer repels the membrane leading to a supported membrane on top of an extended PEG layer yet still residing within a microwell reactor. In FIG. 3C, the PEG moieties 48 are grafted onto single surfaces, either the lipid membrane 46 or the underlying support 44. The tails of the PEG moieties then provide a thermodynamic restraining force to constrain the lipid membrane within the reactor well referred to herein as a hydrophobic interaction. This approach maybe a preferred way to support a bifunctionalized membrane at an energetically favorable distance of choice above the underlying nanoporous material. The lengths of the PEG chains and their density on the underlying substrate can be varied to vary the elevation of the membrane within the reaction well.

The membrane films can include a receptor, transmembrane protein, or protein transducer to interact with an analyte. The invention is not limited to the use of any particular protein. In certain embodiments, a protein that can function as a molecular transporter across the membrane film can be used in the bifunctionalized membrane. It should be noted that the bioanalytical device is equally suitable in applications involving efflux of an analyte or uptake of an analyte, depending on the bioactivity of the protein transducer selected. Examples of protein transducers than can be used in the present technology include proteins associated with multi-drug resistance such as the product of the human MDR1 gene, P-glycoprotein (including MDR efflux pump, peptide efflux pump and phospholipid flippase), and the product of the human BSEP gene, the bile salt export pump (both members of the APT-binding cassette superfamily, described below) and other multi-drug resistance-associated proteins (MRPs), mitoxantrone-resistance proteins (MXR1/BCRP/ABCP/ABSG2), and porins. Another example is cyt bc, a complex of cytochrome b and c. ATP synthase can be driven by the H⁺ gradient generated by co-immobilized cyt bc complex.

ABC transporters are but one example of a transducer for use in the present invention. The ATP-binding cassette (ABC transporter) superfamily contains both uptake and efflux transport systems. ATP hydrolysis, typically without protein phosphorylation, energizes transport across the cell membrane. There are dozens of families within the ABC superfamily, and family generally correlates with substrate specificity. The transporters of the ABC superfamily consist of two integral membrane domains/proteins and two cytoplasmic domains/proteins. The uptake systems (but not the efflux systems) additionally possess extracytoplasmic solute-binding receptors. Both the integral membrane channel constituent(s) and the cytoplasmic ATP-hydrolyzing constituent(s) may be present as homodimers or heterodimers.

The superfamily includes prokaryotic ABC-type uptake transporter families including, without limitation: Carbohydrate Uptake Transporter-1(CUT1); Carbohydrate Uptake Transporter-2 (CUT2); Polar Amino Acid Uptake Transporter (PAAT); Hydrophobic Amino Acid Uptake Transporter (HAAT); Peptide/Opine/Nickel Uptake Transporter (PepT); Sulfate Uptake Transporter (SulT); Phosphate Uptake Transporter (PhoT); Molybdate Uptake Transporter (MolT); Phosphonate Uptake Transporter (PhnT); Ferric Iron Uptake Transporter (FeT); Polyamine/Opine/Phosphonate Uptake Transporter (POPT); Quaternary Amine Uptake Transporter (QAT); Vitamin B12 Uptake Transporter (VB12T); Chelate Uptake Transporter (FeCT); Manganese/Zinc/Iron Chelate Uptake Transporter (MZT); Nitrate/Nitrite/Cyanate Uptake Transporter (NitT); Taurine Uptake Transporter (TauT); Putative Cobalt Uptake Transporter (CoT); Thiamin Uptake Transporter (ThiT); and Brachyspira Iron Transporter (BIT).

The superfamily also includes bacterial ABC-type efflux transporter families including, without limitation: Capsular Polysaccharide Exporter (CPSE); Lipooligosaccharide Exporter (LOSE); Lipopolysaccharide Exporter (LPSE); Teichoic Acid Exporter (TAE); Drug Exporter-1 (DrugE1); Putative Lipid A Exporter (LipidE); Putative Heme Exporter (HemeE); β-Glucan Exporter (GlucanE); Protein-1 Exporter (Prot1E); Protein-2 Exporter (Prot2E); Peptide-1 Exporter (Pep1E); Peptide-2 Exporter (Pep2E); Peptide-3 Exporter (Pep3E); Probable Glycolipid Exporter (DevE); Na⁺ Exporter (NatE); Microcin B 17 Exporter (McbE); Drug Exporter-2 (DrugE2); Microcin J25 Exporter (McjD); Drug/Siderophore Exporter-3 (DrugE3); Putative Drug Resistance ATPase-1 (DrugRA1); and Putative Drug Resistance ATPase-2 (DrugRA2).

The superfamily also includes other ABC-type efflux transporter families, mostly eukaryotic, including, without limitation: Multidrug Resistance Exporter (MDR) (includes P-glycoprotein P-gP); Cystic Fibrosis Transmembrane Conductance Exporter (CFTR); Peroxysomal Fatty Acyl CoA Transporter (FAT); Eye Pigment Precursor Transporter (EPP); Pleiotropic Drug Resistance (PDR); α-Factor Sex Pheromone Exporter (Ste); Conjugate Transporter-1 (CT1); Conjugate Transporter-2 (CT2); MHC Peptide Transporter (TAP); Heavy Metal Transporter (HMT); Cholesterol/Phospholipid/Retinal (CPR) Flippase; and Mitochondrial Fe/S Protein Exporter (MPE).

P-gp (P-glycoprotein) is a member of the ATP binding cassette (ABC) superfamily of membrane transporters, with toxin binding domains localized within the transmembrane regions. It is an energy-dependent multidrug transporter that reduces the accumulation of an extremely broad range of structurally unrelated hydrophobic and amphipathic molecules within cells. P-gp is known to efflux cytotoxic drugs out of cells and to limit the influx of drugs into cells. Known substrates include vinblastine, daunomycin, actinomycin D, taxol, colchicine, verapamil and rapamycin. P-gp is believed to play a protective barrier role in normal tissues, defending them from the damaging effects of toxins, dietary drugs and other harmful environmental agents. However, because it plays a major role in drug resistance, P-gp is making it the subject of intense interest to the pharmaceutical community. Thus, although there are many membrane proteins of interest, P-glycoprotein (P-gp) is one important target for use in the biofunctionalized membranes of the invention due to the important role it is thought to play in broad-based resistance to chemotherapies.

Human P-gp is an integral membrane protein comprised of two homologous halves each thought to span the plasma membrane bilayer six times with each half containing an ATP binding site (Gottesman et al., Annu. Rev. Genet. 29, 607 (1995)). (FIG. 2). Topology studies reveal that both the amino and carboxyl termini of P-gp are located in the interior of the cell. The drug binding sites are localized to the transmembrane domains of the transporter (Greenberger, J. Biol. Chem. 268, 11417 (1993); and Bruggemann et al., J. Biol. Chem. 267, 21020 (1992)) whereas the ATP sites are cytosolic. Hydrolysis of adenosine triphosphate (ATP) on the cytosolic surface of the membrane is coupled to the transport of substrate molecules out of the cell, which means that active transport is coupled to energy consumption and local pH.

Still other transducers for use in the present invention include human ATP-Binding cassette transporters, which number about 48 (see http://nutrigene.4t.comlhumanabc.htm) and include the ABC1 family (subfamily ABCA), MDR family (subfamily ABCB), MPR family (subfamily ABCC), ALD family (subfamily ABCD), OABP family (subfamily ABCE) GCN20 family (subfamily ABCF) and White family (subfamily ABCG). For a review of yeast ABC transporters, see Taglicht et al., Meth. Enzymol. 1998, 292:130-162.

The reactor can also include a biocompatible medium between the underlying substrate and the bilayer. Examples of biocompatible medium include water, saline, a mixture of water and glycine (e.g., 50:50 v/v water:glycerol to about 80:20 v/v water:glycerol). Additionally, the biocompatible medium can include a variety of known hydrogels useful for investigating cellular processes.

An indicator moiety can be disposed within either the medium in the reaction well and/or the lipid membrane. The indicator moiety can be used to either optically, chemically, electrochemically, electromagnetically, or electrically detect transport of an investigated analyte across the lipid membrane and detect the reaction between an investigated analyte and a protein receptor embedded or attached to the lipid bilayer. Examples of detectable species include dye molecules, enzymes, electrochemically active species, and the like.

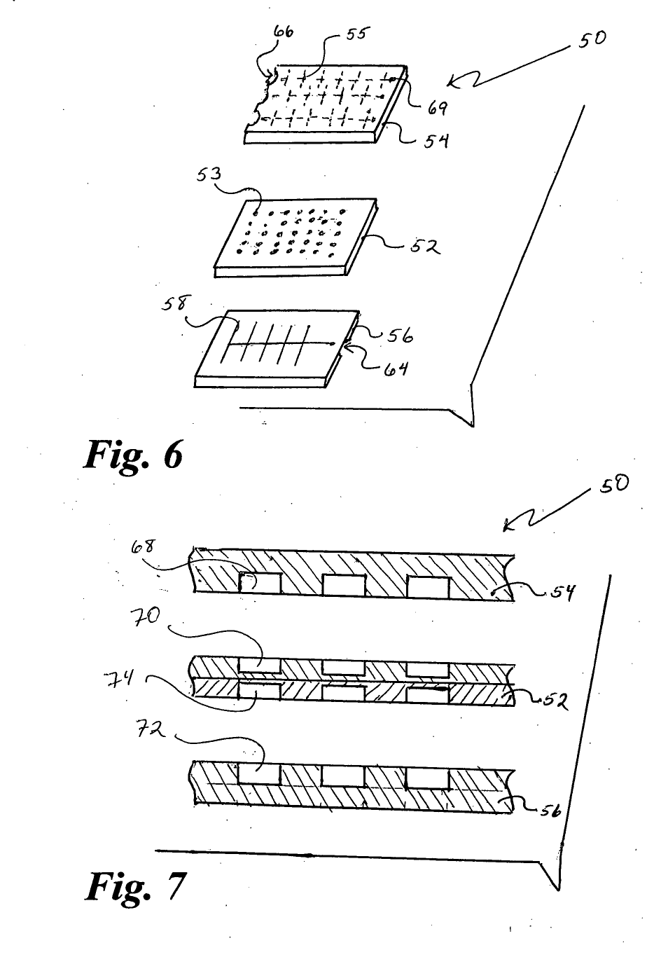

FIG. 6 is an exploded view of another embodiment of a biosensing device 50 in accordance with the present invention. Biosensing device 50 includes a wafer 52, having a plurality of microreactors 53 formed therein, and an upper cover 54. Wafer 52 can be configured as described above for wafer 11 and/or wafer 31. Upper cover 54 is shown to overlay the wafer 52. Additionally, upper cover 54 includes a plurality of channels 55 formed therein (shown in hidden detail with dashed lines). Typically, one or a plurality of fluid delivering channels 55 are formed on the underside surface of upper cover 54. Biosensing device 50 also optionally includes a lower cover 56. Lower cover 56 can be provided similarly as described above for upper cover 54. It can be seen that lower cover 56 also includes a plurality of fluid delivering channels 58 formed therein. Additionally, both upper cover 54 and optional lower cover 56 can include sample ports 66 and 64, respectively. Sample ports 66 and 64 can allow the introduction of a fluid medium into the channels 55 and 58, respectively, to be delivered to specific locations, i.e., to specific microreactors 53 located on wafer 52. Referring specifically to upper cover 54, it can be observed, that one, two, or more sample ports can be provided. Each sample port can be used to provide a fluid communication to a select one or set of fluid conduits formed in the respective cover. Additionally, to promote the capillary action of the fluid within the conduits, a vent port 69 should also be provided for each conduit line. This provides efficient wicking or promotes fluid flow through the channel(s) via capillary action.

Referring additionally to FIG. 7, which is a cross-sectional view of the biosensing device 50, it can be seen in this view that a specific conduit 68 overlies one microwell 70 or a set of microwells. Similarly, for lower cover 56, a second set of conduits 72 can be positioned to overlie an opposing set of microwells 74 formed in wafer 52. This provides a pathway for providing either a specific analyte or sample containing an analyte to a select set of microreactors. Additionally, with the optional lower cover 56, selected reagents, indicator moieties, buffers, and the like can be provided to a second set of microreactors. In preferred embodiments, the second set of microreactors can be positioned to allow fluid communication to a first set of microreactors, thereby allowing transfer of applied reagents, analytes, buffers, and the like from one microreactor to the other.

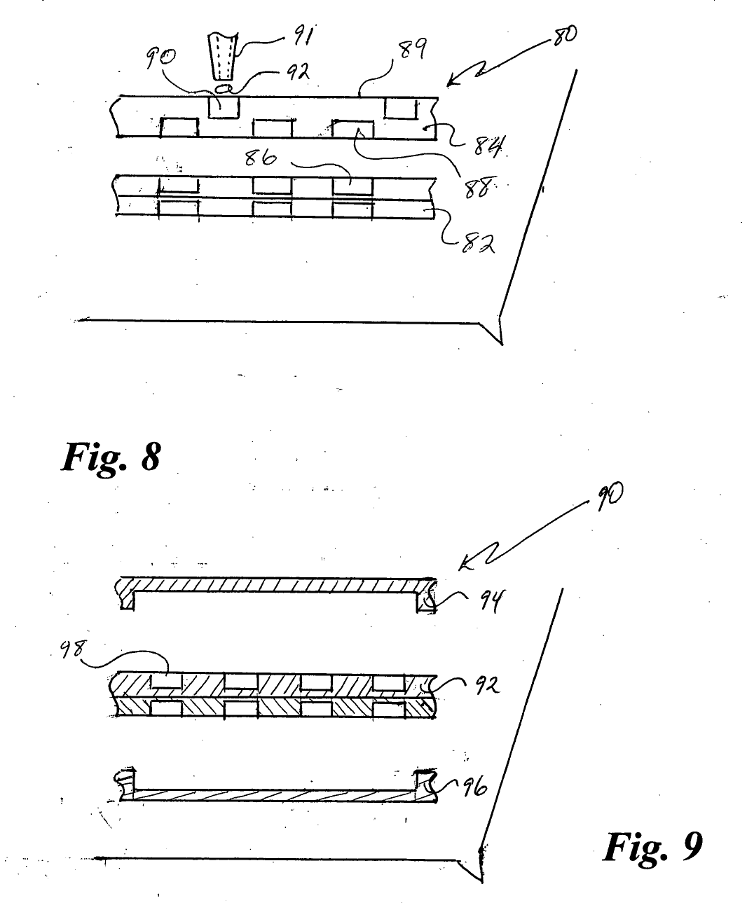

FIG. 8 is an exploded view of another embodiment of a biosensing device 80 in accordance with the present invention. Biosensing device 80 also includes a wafer 82 having a plurality of microreactors 86 formed thereon. Wafer 82 can be configured substantially as has been described above for wafers 11 and 52.

Biosensing device 80 also includes a cover 84. Cover 84 has a plurality of fluid channels 88 formed therein. In one embodiment, cover 84 is composed of a porous substrate. This allows introduction of a fluid-containing analyte, reagent, indicator moiety, buffer, and the like directly on the exterior surface 89, which fluid can then be transferred through the porous or mesoporous membrane into one or more of the microwells 86. In other embodiments, cover 84 includes a plurality of channels or wells 90 into which the inkjet 91 can deposit a drop 92. When provided, well 90 provides fluid communication to a select one of the conduits 88 or to a select number of conduits formed on the opposing surface of cover 84. Cover 84 thus provides a means for introducing either the sample or other fluid medium into a select one or all of the microwells 86 formed in wafer 82.

FIG. 9 provides yet another embodiment of a biosensing device 90 provide in accordance with the present invention. Biosensing device 90 includes a wafer 92 which can be configured substantially as has been described above for wafers 11 and 52. Additionally, device 90 includes at least one cover 94 and optionally a second cover 96. Covers 94 and 96 are composed of a porous, preferably a micro- or mesoporous, membrane which can be used to filter either a sample for testing or one or more of the fluids which are deposited on the outer surfaces of the respective membranes 94 and 96. The fluids or analytes which have been deposited thereon can then flow into one or more of the microwells 98 formed in wafer 92.

The biosensors in accordance with the present invention can be prepared by first selecting a suitable substrate. Examples of substrates are discussed above. The substrate can then be microfabricated to provide a grid-like structure in silica. A polymeric coating can be deposited onto the nanoporous substrate. Once the reaction wells have been defined in the substrate/polymeric coating, surface chemistries such as silane or thiol monolayers can be used to control absorption of proteins in lipids onto the surface and in the reaction wells. Protein and membrane chemistries that are compatible with “inkjet” technologies are preferred for use in constructing the addressable arrays in accordance with the present invention. In one form of the invention, only one protein will be deposited in each of the microwells. In alternative forms of the invention, a single or multiple protein-lipid combinations are deposited in the microwells using an arraying or microfluidics delivery system.

The substrate/polymeric coating can be used as is or further components can be added. For example, two of the substrates with the microreactors can be fabricated together back-to-back as illustrated as membrane 52 in FIG. 6. Optionally or in the alternative, one or more covers can be attached to overlay the microreactor field. The covers can include fluid handling/delivery conduits or a filter medium or both as desired for the particular application. In these embodiments, the biosensor devices can find particular advantageous use in on-site testing. The samples and/or reagents can be introduced through one or more ports formed in the device. The resulting device can be used to carry out a single reaction or multiple reactions and/or analyses.

The inkjet delivery can be carried out either on the continuous (CIJ) mode or a drop-on-demand (DOD) mode. The DOD mode is preferred for the present invention because it can utilize either piezo or thermal drop generation techniques. Preferred methods use a piezo drop generation since this does not require thermal energy that can heat up the sample and which may ultimately degrade the analytes of interest.

It has recently been discovered that a novel method for generating drops can produce drops with radii that are much smaller than the nozzles which produce them. This new technique can be implemented to reduce the drop size and hence the spot size for use in the present invention. Drop liquids, as mentioned above, can contain the lipid membranes, proteins, and fluid medium for use or deposition in the microwells.

Once the biodevices of the present invention have been prepared as described herein, they can be used to investigate analytes or biologics of interest. The analytes or biologics of interest can be a variety of molecules including various analytes, enzymes, and membrane proteins or agents that are known or suspected to cross a lipid membrane. In certain embodiments of the present invention, membrane proteins, protein receptors, and transmembrane transducers can be investigated against specific analytes. The activity of specific protein-analyte pairs can be achieved using indicators, such as pH-sensitive dyes which can be mobilized in the fluid medium. Optical techniques such as phase microscopy, differential interference contrast microscopy, fluorescence microscopy, polarization microscopy, raman microscopy, infrared reflection absorption spectroscopy (IRAS), and ellipsometry can be used to characterize the chemical and physical state and mechanism of action of the proteins and analytes of interest. The transport activity of the embedded proteins, transducer proteins, and protein receptors can be compared to the activity within the fluid medium.

In operation, the biosensor can be used to evaluate an analyte of interest. The analyte of interest can be a drug, toxin, or other naturally occurring or synthetic molecule or molecular complex. The analyte of interest or a solution containing the analyte of interest can be applied to one or more pre-selected, addressable reaction well(s) via inkjet deposition. This technique deposits the analyte onto the outer or “extracellular” side of the membrane. The analyte can then be transported across the membrane or react with (bind to) a protein receptor exposed to the extracellular side of the membrane. If the analyte is transported through the membrane into the fluid medium, the analyte can induce activity either with a protein transducer in the membrane or an indicator molecule in the medium molecule. This, in turn, either directly or indirectly can give rise to a detectable signal, either optically, electrically, or electrochemically.

The biosensors of the present invention allow analysis of a select number or a single analyte against an array of receptors or transducers. Alternatively, the biosensor can allow the analysis of a single protein receptor or transducer confronted with a library of different analytes. In either mode of analysis, a solution or pre-selected solution of analytes is individually applied to a specific, addressable microreactor, much the same as the membrane and/or fluid medium are applied. This can allow the investigation of different receptors and transducers that may be found on cellular surfaces.

One important application of the biosensors will be to investigate membrane proteins that are asymmetric. Membrane proteins are often asymmetric as their function is to transduce signals, molecules, or energy across a lipid bilayer. These proteins have reaction centers designed to operate either in the environment of the cytoplasm and periplasm or across the organelle in which they are localized. Membrane protein sensors have typically not been able to take advantage of this asymmetry and thus have not taken full advantage of the function of the proteins. Rather, these sensors have used proteins that are randomly oriented in lipid vesicles or bilayers supported on a surface. The micropattemed nanoporous membranes provide at least two advantages for membrane protein sensing. First, the nanoporous membrane structure provides a permeable barrier that protects the delicate vesicle and bilayers from hydrodynamic shear and species that can disrupt their structure. Second, the micropatterned nanoporous membranes allow the environment of a specific side of the bilayer membrane to be addressed. If the membrane proteins are oriented in the bilayers, this will allow the pH or the concentration of a reactant to be regulated on a specific side of the protein. This will also provide the means to analyze the reaction products at a specific surface of the membrane.

For the purpose of promoting further understanding and appreciation of the present invention and its advantages, the following Examples are provided. It will be understood, however, that these Examples are illustrative and not limiting in any fashion.

### EXAMPLE 1

### Preparation of a Nanoporous Biosensor

A nanoporous biosensor device for use in the present invention can be prepared according to the following procedure. A wafer of γ-alumina sold under the trade name Anopore by Whatmann was initially coated using an epoxy resin (SU-8) to prepare the microreactors in six processing steps: spin coat, soft bake, expose, post expose bake, develop, and hard back. To obtain maximum process reliability, residual materials were removed from the nanoporous membranes using an ozone gas (Jetlight Co., Irvine, Calif.) that is capable of rapidly permeating the membrane. Before coating, the nanoporous membranes were baked at 90° C. for 15 minutes to ensure all residual moisture was removed. The membranes were then taped to a polymer coated paper template and placed on the vacuum chuck of the spin coater (Headway Research Inc, Garland, Tex. The polymer coated paper provides an impervious layer that prevents the photoresist from being drawn through the pores of the membrane during the spin-coating process. The SU-8 (MicroChem Corp., Newton, Mass.) spin coating was carried out at 1,500 RPM for 50 seconds to create 20-40 micron thick film, as determined by profilometry (Tencor Alpha Step 200 Profilometer, Milpitas, Calif.). After coating the membrane, the template was removed and the device was “soft baked” at 65° C. for 5 minutes and then at 95° C. for 10 minutes on a digital hot plate (Barmstead/Thermolyne, Dubuque, Iowa). Pattern transfer of the mask of the microreactors was carried out in Suss MJB-3 mask aligner (SUSS MicroTec Inc, Garching, Germany) at a 1:1 image transfer ratio using a 365 nm light source of 23 mW/cm² intensity for 12 seconds. After exposure, the device was baked at 65° C. for 5 minutes and then at 95° C. for 10 minutes. The device was then developed and rinsed with reagent grade isopropyl alcohol (Malinckrodt Baker Inc., Paris, Ky.). A “hard bake” at 120° C. for 10 minutes was found to be beneficial for creating a durable membrane bonding to the SU-8 film.

The microreactor and membrane structure and physical properties were characterized using several forms of microscopy, x-ray photoelectron spectroscopy (XPS), and permeability measurements. Electron microscopy (JSM-840, JEOL, Peabody, Mass.), atomic force microscopy (Digital Instruments, Santa Barbara, Calif.), and profilometry all confirmed that the SU-8 microstructure was formed without creating significant stress in the membrane. The chemical properties of the membrane surface in the bottom of the microreactor well were characterized using XPS (Kratos Axis ULTRA, Kratos Analytical Inc., Chestnut Ridge, N.Y.). The aromatic C 1s peak made up 48.1% of the relative atomic composition of the surface while the Al 2p peak only made up 2.8% of the relative atomic composition of the surface. The strong carbon signal and weak aluminum signal was indicative that the alumina membrane was coated with a thin film of SU-8.

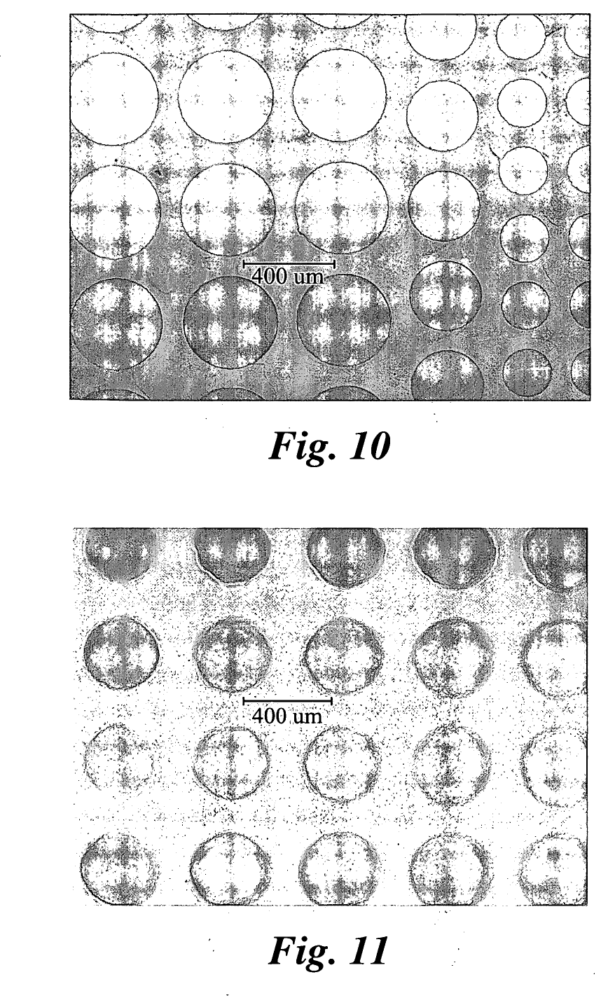

FIG. 10 is an optical micrograph of an array of circular microreactors that have been constructed on a nanoporous alumina substrate. The brown areas in this figure are alumina substrate while the white areas are a 30μ thick polymer film that forms the microfluidics layer. The microreactors were fabricated on 60μ thick aluminum substrates (Whatman Company, Clinton, N.J.) that have a nominal pore size of 20 to 200 nm. The polymer layer is constructed from SU-8, which is an epoxy-based negative photoresist that has been used to create high aspect ratio polymeric microfabricated devices. The rather large size of the reactors in this device was chosen to allow each reactor to be readily addressable with an inkjet arrayer.

The permeability of the substrates was measured with both nitrogen and water to determine if the residual SU-8 film influenced the permeability of the nanoporous substrate. The permeability was measured with an instrument composed of a pressure driven fluid, pressure transducer, flow meter, and substrate holder, which has been described previously. Hovijitra, N.; Lee, S. W.; Shang, A.; Wallis, E.; Lee, G. U.; SPIE Defense and Security Symposium, Orlando, Fla. 12-16, Apr. 2004. The permeability, Lₚ, was measured from the flow through the substrate at a defined pressure

$${L}_{p} = \frac{Δ F}{A Δ P}$$

where ΔF is flow, A is the area if the substrate, and ΔP is pressure. The results of the nitrogen and water permeability measurements on a 200 nm nominal pore size substrate are shown in Table 1. The permeability of the substrate after treatment with SU-8 was found to be significantly lower than that of the bare substrates, which confirmed that a thin layer of SU-8 coated the substrate surface.

TABLE 1
Permeability measurements on alumina membranes substrates
that have a nominal pore diameter of 200 nm

| | Devel- | Ar/O₂ | Nitrogen | |
|---|---|---|---|---|
| | opment | Plasma | Permeability | Water |
| | Time | Reactor | (×10⁻⁶ | Permeability |
| | (min) | Conditions | m/Pa · s) | (×10⁻⁸ m/Pa · s) |
| Bare substrate | — | — | 4.29 | 2.14 |
| SU-8 Device | 1 | — | 0.13 | 0.11 |
| SU-8 Device | 4 | 200 W 5 min | 2.41 | 0.73 |
| SU-8 Device | 4 | 250 W 5 min | 3.56 | 1.18 |
| SU-8 Device | 4 | 300 W 5 min | 4.24 | 1.37 |

The thin film of SU-8 was removed from the substrates by making several modifications to the microfabrication process. First, the development time of the SU-8 film was increased from 1 to 4 minutes, which resulted in a two-fold increase in the permeability of the substrate. Second, the device was exposed to an Ar/O₂ plasma (Branson Series 3000 Barrel Etcher, Branson International Plasma Corporation, Hayward, Calif.). Care was taken in selecting the plasma treatment conditions as the plasma is highly energetic and can quickly decompose the SU-8 microstructure. It was found that good results can be obtained when the device was exposed to the Ar/O₂ plasma for approximately 5 minutes and maintained at about 300 W of power. The resulting device exhibited a water permeability that is 80% of the bare substrate (Table 1). The fact that the nitrogen permeability of the membranes was indistinguishable from that of the bare membranes under these conditions suggested that the SU-8 was almost completely removed, but that the surface of the substrate retained some of the hydrophobicity of the polymer. It was found that Ar/O₂ plasma decreased the water contact angle on SU-8 from 105±0.20° to less than 15°. This was slightly higher than the bare alumina membranes. Optical microscopy and AFM images of the SU-8 surface after Ar/O₂ plasma treatment indicated that the surface was roughened.

### EXAMPLE 2

### Detection of Horseradish Peroxidase

The asymmetric biochemical reactions were demonstrated in the nanoporous substrate devices using the horseradish peroxidase (HRP) enzyme as a model catalyst according to known procedures. Peroxidases are a class of enzymes known to decompose two molecules of hydrogen peroxide into water through a superoxide ion pathway. HRP has been used as an immunohistochemical label as its specificity for the second molecule of hydrogen peroxide is low and other electron donors can be substituted. This allows HRP to be used as a catalyst for chemilluminescent and colorimetric substrates. In this work, the calorimetric reaction shown in Scheme 1 was used to detect the presence of the enzyme (see below). In this reaction, the 4-chloro-1-naphtol (4-CN) and N,N′-diethyl phenylenediamine dihydrochloride (DEPDA) react to form a water insoluble product that has a deep blue color.

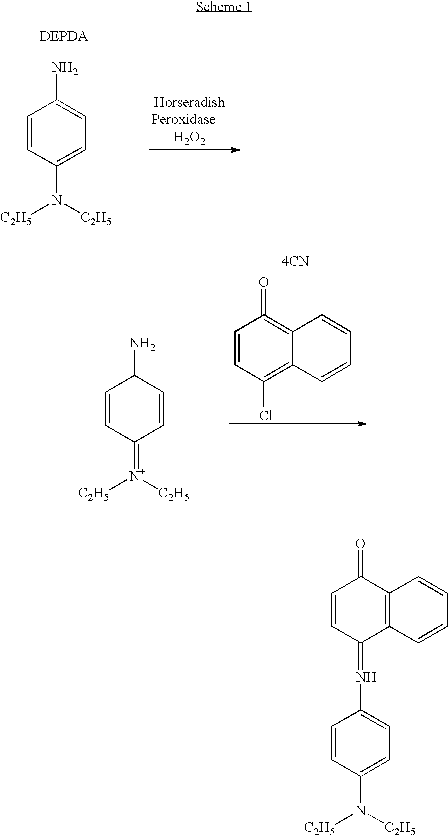

In the asymmetric assay, the back of the membrane device was first exposed to a dye solution, which was composed of 1.3 mM 4-CN (Sigma), 0.23 mM DEPDA (Sigma), and 4.4 μm M H₂O₂ in 10 mM phosphate buffer (PB: 5 mM Na₂HPO₄, 5 mM NaH₂PO₄,) at pH 7.0. HRP was then introduced onto the microreactor's membrane surface at 10 μg/ml HRP-labeled streptavidin (KPL, Gaithersburg, Md.) in a phosphate buffered saline solution (PBS: 5 mM Na₂HPO₄, 5 mM NaH₂PO₄, 5.4 mM KCl, 0.12 M NaCl) at pH 7.0. The HRP reaction was run until a uniform blue color dye could be visibly detected, which took approximately 60 seconds.

FIG. 11 presents on optical micrograph of the reaction wells in which reflected light has been used to image the substrate surface. The bottom of the microreactors where the alumina substrate is exposed has been stained a deep blue while no color change was detected in areas where the SU-8 photoresist coats the substrate surface. No color change took place in microreactors when only HRP was added to the front surface, but a slow color change was observed when only the dye solution was added to the back surface. This slow color change in the absence of HRP is due to the much slower non-enzymatic reaction of 4-CN with DEPDA.

The overall rate of reaction in the microreactors is controlled by the mixing of the HRP-streptavidin conjugate with the dye substrate and the reaction kinetics of HRP. HRP is known to have a high turnover number of approximately 1000 sec⁻¹, thus the dye components that reach the enzyme are almost immediately converted into the insoluble product. This suggests that the overall rate of reaction is determined by the diffusion of the hydrogen peroxide and dye components to the HRP-streptavidin conjugate. These molecules were free to move through the substrate as the nominal pore size was at least 20 nm. Although the HPR-streptavidin conjugate is free to diffuse in the reactor, its diffusion coefficient is approximately 0.05×10⁻⁵ cm²/s, which is at least one order of magnitude slower than that of the dyes and hydrogen peroxide. These observations suggested that the substrate molecules reacted with HPR-streptavidin conjugate in the immediate vicinity of interface of the membrane and that the overall rate of reaction was set by the diffusion of the dye components to the surface of the membrane from the pores. The fact that the blue color was localized on the substrate surface of the reactor is consistent with this model. The HRP reaction was also run in a configuration in which the HRP-streptavidin conjugate was first adsorbed on the substrate surface of the microreactor and then the dye solution was added to the opposite side of the reactor. In this case, the rate of reaction was at least 10 times slower, which is a result of the fact that the dye components must diffuse through the 60 micron thick nanoporous substrate. The rate of transport of the dye components through the substrate can be increased by using pressure driven flow.

### EXAMPLE 3

### Biosensor Preparation

The following demonstrates a microfabricated biosensor can be used for high throughput screening of membrane protein functions using a micro-fluidity device inkjet arrayer. The membrane protein gramicidin was selected because its function has been extensively studied. Gramicidin is a hydrophobic protein consisting of 15 amino acids in a sequence of Val-Gly-Ala-Leu-Ala-Val-Val-Val-Trp-Leu-Trp-Leu-Trp-Leu-Trp. Gramicidin acts as a channel former through a bolalipid membrane. Two gramicidin molecules, each in a β-helix structure, join at their N-formyl terminus to generate a 30 residue peptide that extends across the lipid bilayer. Numerous studies have indicated that the gramicidin dimer has an outer and inner diameter of about 15 angstroms and 5 angstroms, respectively. The hydrophobic side chains are all located inside of the β-helix and the hydrophilic backbone carbonyls extend out of the helix and into the surrounding lipid bilayer.

Preparation of dye-entrapped lipid vesicles. Dioleoylphosphatidylcholine (DPPC), biotinylated dioleoylphosphatidylethanolamine (bio-DPPE), and PEGylated stearyloleoylphosphatitylcholine (PEG-SOPC) were purchased from Avanti Polar Lipids of Alabaster, Pa.

Multi-lamellar-vesicles (MLV) preparation. A 95% solution of DPPC, 1% bio-DPPE, and 1% PEG-SOPC were mixed in chloroform to provide a total lipid concentration of about 10 mg/ml. A glass vial was coated with the chloroform solution of the lipids. The solvent was removed by evaporation under a stream of dry nitrogen while vortexing the vials over a period of 1 to 2 hours. Final traces of the solvent were removed under reduced pressure using a vacuum pump maintained at room temperature for about 3 to 4 hours. The resulting dried lipids were then re-suspended in a buffer solution of 20% glycerine, 80% water with 0.1 M KCl, 5 mM Tricine, 5 mM MES, and 5 mM pyranine (the dye) at the desired pH The re-suspended lipid solution had a final lipid concentration of about 10 mM. The re-suspended lipid solution was then subjected to 10 freeze-thaw cycles performed at above 60° C. to provide the MLVs.

Large-unilamellar-vesicles (LUV) preparation. The LUVs were prepared according to the same procedure described above for the MLVs. These were transferred to an extruder (Schiema Technical Services of Richmond, British Columbia) and extruded (10×) through a standard polycarbonate filter (Osmonic, Westborough, Mass.) (0.1 μm pore sized) maintained at about 60° C. The residual dye pyranine outside the LUV vesicles was removed by gel chromatography (100 grams Sephadex G-25, Amersham Biosciences, Uppsala, Sweden). The vesicles were evaluated for extraneous dye via a UV/VIS absorption scanning against a buffer solution. Gramicidin was added to the vesicles according to the following procedure. Gramicidin was dissolved in ethanol and mixed with the lipids re-suspended in the buffer described above which provided a gramicidin concentration of about 10 μM. The gramicidin concentration was monitored using fluorometry and the UV/VIS spectrophotometer. Vesicle solutions without gramicidin were also maintained as controls and were monitored accordingly.

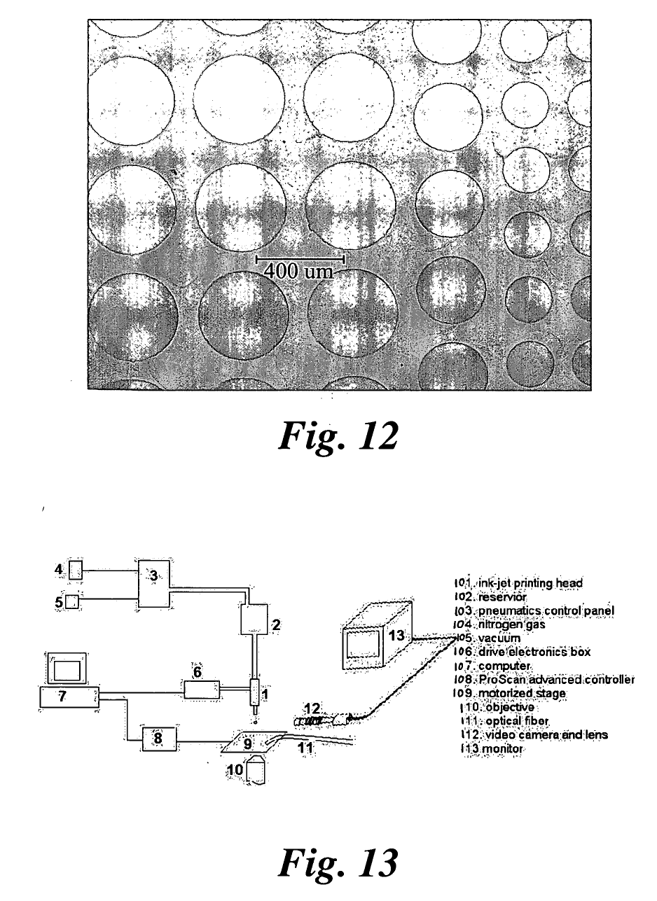

The microfabricated biosensor was prepared as described in Example 1, except that instead of an aluminum nanoporous substrate, a 200μ thick micro-cover glass was used as, the substrate. FIG. 12 is a scanned image of the resulting microfabricated biosensor having microreactors of 400, 500, and 600 microns in diameter on a glass substrate.

The inkjet arrayer was prepared by using an optical microscope to dispense liquid into the microreactor wells. The inkjet print head allows sub-nano liter volumes of reagents to be dispensed into each of the reactor wells. The printing head is a single glass micro-dispenser consisting of an annular piezoelectric actuator bonded to a glass capillary, connected, in turn, at one end to a fluid supply. The other end has an orifice with a diameter of about 20 to 60 microns. Applying a voltage to the actuator varies the capillary tube diameter, producing pressure variations of the fluid enclosed within the capillary. The pressure variations propagate down the capillary toward the orifice. This sudden change in cross-sectional (acoustical impedance) at the orifice causes a drop to form (DOD).

FIG. 13 illustrates a schematic of the inkjet arrayer and inverted optical microscope assembly for use in the present example. It was determined that a wide variety of fluids can be dispensed from this inkjet dispenser. It is preferable that the viscosity of the fluids be lower than about 40 centipoise to provide a uniform microdrop. The drop volume is a function of the fluid, the orifice diameter, and actuator driving parameters (i.e., voltage and timings). Typically the drop volume can be consistently controlled to between about 15 to 200 picoliters ˜±22%.

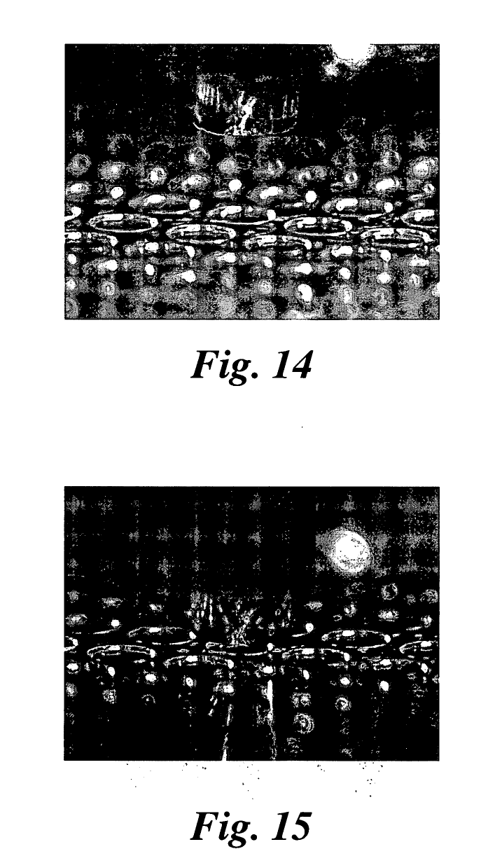

FIGS. 14 and 15 illustrate images of the print head orifice approaching the micropattern biosensor. To protect the tip or orifice of the print head, a video camera is used to monitor the distance between the end of the glass capillary, the print head, and the surface of the biosensor.

Characterization of humidity controlled chamber. It was determined that precise control of humidity during dispensing and operation greatly increased the control and sensitivity of the biosensor. To consistently maintain the volume as small as 2 to 3 nanoliter, optimal conditions were determined considering evaporation and diffusion of the fluid. It was determined that use of pure water as a carrier solution was less desirable since pure water evaporates relatively easily at 95% relative humidity. However, using a fluid containing 20% glycerine and 80% water or buffer (by volume) provides for much slower evaporation. In fact, the 20:80 (v/v) glycerine:water solution is in equilibrium with about 96 to 97% relative humidity. A humidity chamber was developed and secured around the dispensing head and the biosensor.

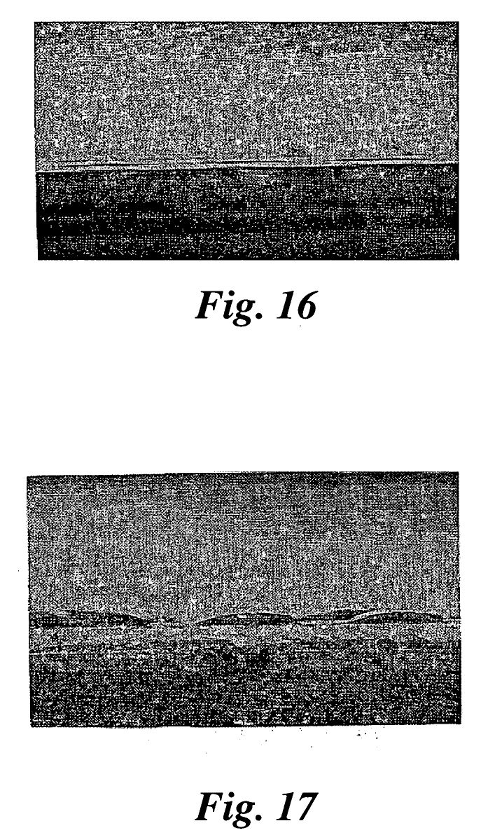

FIGS. 16 and 17 are scanned images of the biosensor. FIG. 16 illustrates a biosensor having a membrane with a flat fluid/air interface in a chamber maintained at about to about 100% relative humidity. FIG. 17 illustrates a similar biosensor having a convex fluid/air interface when the relative humidity in the chamber was maintained at about 100% for more than 2 hours.

Chemical treatment of the reaction wells. Biotin groups were immobilized on the exposed substrate surface in the reaction wells via a PEG bivalent linker using a PEG derivative bi-functionalized with α-biotin, ω-NHS polyethylene carbonate (Shearwater Polymers, Huntsville, Ala., mw 3400). First, the substrate surfaces were ozone-cleaned. Then the entire surfaces were aminated with polyethyleneimine (PEI) (Polymine SNA, BASF, Rensselaer, N.Y.). Then the biotin-NHS ester of PEG was added. The excess reactants were removed by rinsing with water. It was determined that a solution of 100 μg/ml PEG in PBS buffer (12 mM, pH 7) was sufficient to completely saturate the substrate surface with bound biotin moieties. In a first set of reaction wells, a lipid vesicle without the gramicidin was deposited. In a second set of reaction wells, lipid vesicles containing the gramicidin protein embedded therein were deposited. Both sets of reaction wells were on the same biosensor chip, which was maintained in a humidity chamber at about 95 to 96% relative humidity.

FIG. 18 is a scheme illustrating one of the reactor wells 130 having a plurality of lipid vesicles 132 formed in the well 134. A fluid cassette 136 exists below the membrane formed by the plurality of vesicles 132.

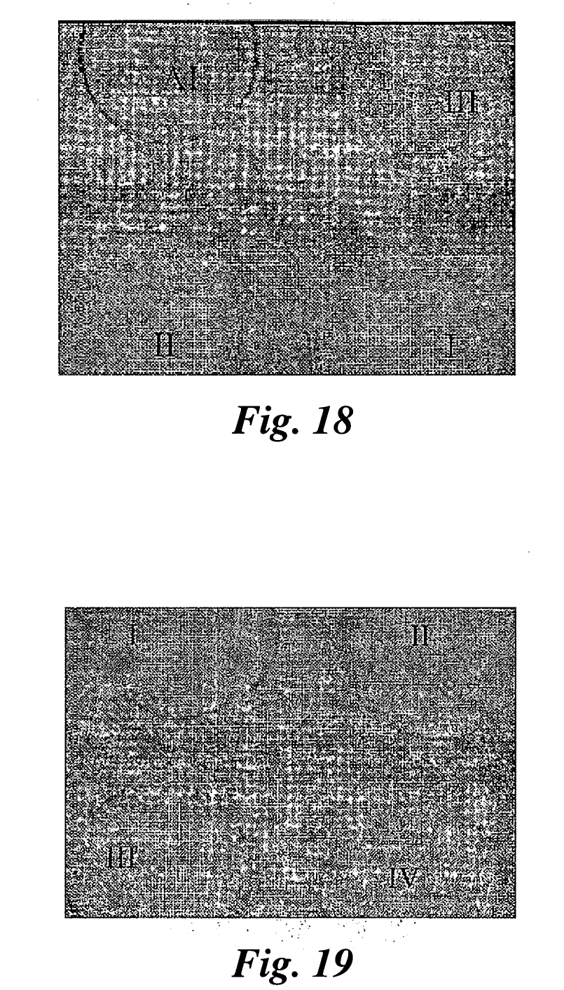

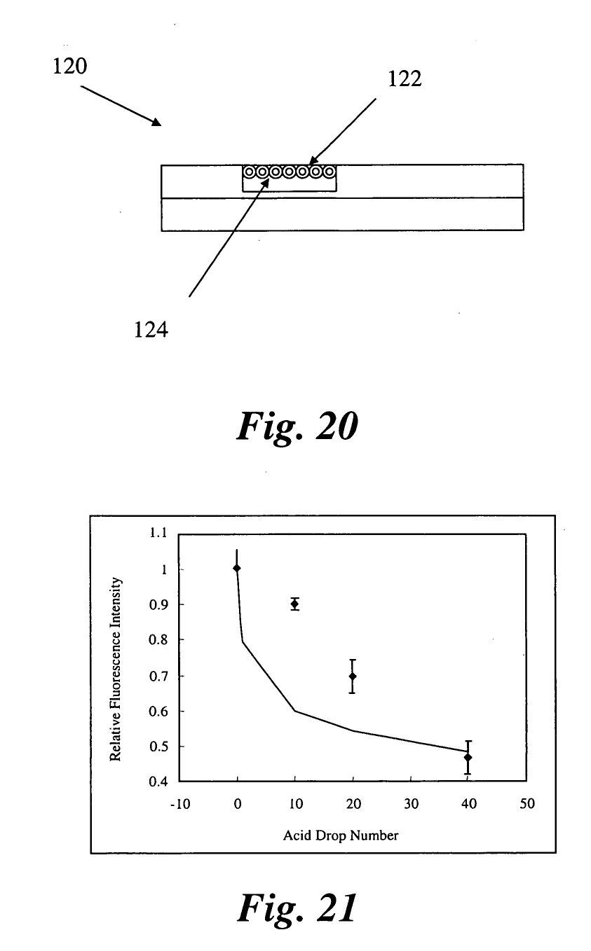

As an initial evaluation, acid (a dilute HCL solution, pH 3) was added to each of the reaction wells. FIG. 19 is a scanned fluorescence image of a microfabricated reactor well with lipid vesicles containing gramicidin molecules embedded therein. FIG. 20 illustrates the reaction wells with lipid vesicles sans the gramicidin molecules. It was found, in the reaction wells that contain the vesicles with gramicidin, that the acid was transported into the fluid inside of the lipid vesicles by observing the color change of the pH-sensitive dye. FIG. 21 is a plot illustrating the relative fluorescence intensity relative to pH and the number of acid drops added to each reaction well.

Consequently, it is demonstrated that the microfabricated biosensor can be used for high throughput screening of membrane proteins and/or analytes of interest. Furthermore, the print head can be used to accurately and consistently dispense nano liter droplets of fluids either to initially develop and prefabricate the reactor wells and/or to deposit analytes of interest in an addressable array.

The present invention contemplates modifications as would occur to those skilled in the art. It is also contemplated that processes embodied in the present invention can be altered, rearranged, substituted, or added to other processes as would occur to those skilled in the art without departing from the spirit of the present invention. In addition, the various procedures, techniques, and operations within these processes may be altered or rearranged as would occur to those skilled in the art. All publications, patents, and patent applications cited in this specification are herein incorporated by reference as if each individual publication, patent, or patent application was specifically and individually indicated to be incorporated by reference and set forth in its entirety herein. Unless specified herein to the contrary, all terms and expressions are used according to their common and customary usage in the art.

Further, any theory of operation, proof, or finding stated herein is meant to further enhance understanding of the present invention and is not intended to make the scope of the present invention dependent upon such theory, proof, or finding.

While the invention has been illustrated and described in detail in the drawings and foregoing description, the same is considered to be illustrative and not restrictive in character, it is understood that only the preferred embodiments have been shown and described and that all changes and modifications that come within the spirit of the invention are desired to be protected.

1. A biosensing device comprising:
a substrate having first surface and an opposite second surface;
a film overlying the first surface, said film defining a plurality of reaction wells each well having a volume of less than about 10 nL and extending into the film to expose a portion of the first surface;
a biocompatible medium disposed in each of said reaction wells; and
a membrane disposed on top of the biocompatible medium.

2. The device of claim 1 wherein the substrate is composed of a material selected from the group consisting of: silicon dioxide, glass, alumina, gold, indium and tin oxide.

3. The device of claim 1 wherein the pores in the substrate have a nominal diameter of less than about 400 nm.

4. The device of claim 3 wherein the pores have a nominal diameter of less than about 200 mn.

5. The device of claim 1 wherein the film is composed of a photoresist material.

6. The device of claim 1 wherein the reaction wells each have a nominal volume of less than about 5 nL.

7. The device of claim 6 wherein the reaction wells each have a nominal volume of less than about 3 nL.

8. The device of claim 1 wherein the biocompatible medium is selected from the group consisting of: water, saline, a hydrogel, and a glycerol/water mixture.

9. The device of claim 1 comprising one or more indicator moieties.

10. The device of claim 1 wherein the membrane is selected from the group consisting of: a lipid monolayer, a bilipid layer, a bolaamphiphile, a triblock copolymer, and a hydrogel.

11. The device of claim 1 wherein the membrane is tethered to the substrate.

12. The device of claim 1 wherein the membrane comprises a membrane protein.

13. The device of claim 12 wherein the membrane protein is tethered to the substrate.

14. The device of claim 13 wherein the membrane protein is a receptor protein.

15. The device of claim 13 wherein the membrane protein is a protein transducer.

16. The device of claim 15 wherein the protein transducer comprises a gramicidin.

17. The device of claim 15 wherein the protein transducer comprises a protein which is a member of the ATP-binding cassette superfamily.

18. The biosensor device of claim 15 wherein the protein transducer comprises a P-glycoprotein.

19. A biosensor device comprising:
a membrane having an outer surface and an inner surface;
a porous substrate in fluid communication with the inner surface of the membrane film, said substrate having defined therein a plurality of reaction wells having a volume of less than about 10 nL containing a fluid medium between the membrane film and the support substrate; and
a protein associated with the membrane or fluid medium.

20-27. (canceled)

28. The device of claim 19 wherein the membrane comprises at least one component selected from the group consisting of: a monolipid, a bilipid, a bolalipid, a bolaamphiphile, a triblock copolymer, and a hydrogel.

29. The device of claim 19 wherein the substrate comprises at least one material selected from the group consisting of silicon, gold and γ-alumina.

30. The device of claim 19 wherein the aqueous compartment comprises an indicator moiety for detecting the activity of the protein transducer.

31. The device of claim 19 wherein the substrate comprises at least one orienting moiety that interacts with the protein transducer to orient the protein within the membrane film.

32. The device of claim 19 further comprising a sensor component for detecting a signal generated from the indicator moiety.

33. The device of claim 32 wherein the sensor component is configured to detect a signal selected from the group consisting of a chemical signal, an optical signal, an electrochemical signal, an electrical signal, and an electromagnetic signal.

34-65. (canceled)
